(19) United States
(12) Patent Application Publication
(10) Pub. No.: US 2025/0274174 A1
(43) Pub. Date: Aug. 28, 2025

(54) SYSTEMS AND METHODS FOR MIMO RANK INDICATOR OVERRIDE

(71) Applicant: Verizon Patent and Licensing Inc., Basking Ridge, NJ (US)

(72) Inventors: Yong Sang Cho, Old Tappan, NJ (US); Kwangil Kim, Ridgewood, NJ (US); Lily Zhu, Parsippany, NJ (US); Jeremy Nacer, Boca Raton, FL (US)

(21) Appl. No.: 18/587,727

(22) Filed: Feb. 26, 2024

(51) Int. Cl. H04B 7/0456

(52) U.S. Cl. CPC H04B 7/0486

(57) ABSTRACT

A device may include a processor configured to receive a multiple-input and multiple-output (MIMO) rank indicator from a user equipment (UE) device. The processor may be further configured to determine that the received MIMO rank indicator is lower than an expected MIMO rank indicator; determine that the UE device satisfies one or more criteria for a MIMO rank indicator override; and override the MIMO rank indicator for the UE device, in response to determining that the received MIMO rank indicator is lower than the expected MIMO rank indicator and determining that the UE device satisfies the one or more criteria for the MIMO rank indicator override.

### BACKGROUND INFORMATION

To satisfy the needs and demands of users of mobile communication devices, providers of wireless communication services continue to improve and expand available services as well as networks used to deliver such services. One aspect of such improvements includes increasing data rates at which mobile communication devices are able receive and send information. Managing high data rates for wireless communication devices may pose various challenges.

### BRIEF DESCRIPTION OF THE DRAWINGS

FIG. 1 illustrates an environment according to an implementation described herein;

FIG. 2 illustrates exemplary components of a device that may be included in a component of an environment according to an implementation described herein;

FIG. 3 illustrates exemplary components of multiple-input and multiple-output (MIMO) rank indicator override system according to an implementation described herein;

FIG. 4 illustrates exemplary components of a user equipment (UE) device database according to an implementation described herein;

FIG. 5 illustrates a flowchart of a process for classifying a UE device as a candidate for MIMO rank indicator override according to an implementation described herein;

FIG. 6 illustrates a flowchart for performing a MIMO rank indicator override according to an implementation described herein; and

FIG. 7 illustrates an exemplary signal flow diagram according to an implementation described herein.

### DETAILED DESCRIPTION OF PREFERRED EMBODIMENTS

The following detailed description refers to the accompanying drawings. The same reference numbers in different drawings identify the same or similar elements.

A cellular wireless network enables user equipment (UE) devices to connect to networks via a Radio Access Network (RAN) and a core network in order to communicate with other devices connected to the RAN, communicate with devices in other networks, access applications or services hosted by a provider network, and/or make use of other types of wireless communication services. For example, Fifth Generation (5G) core network may implement different types of services for UE devices, such as, for example, an enhanced Mobile Broadband (eMBB) service for Voice over Internet Protocol (VoIP) telephone calls and/or data sessions for accessing Internet websites; a massive Internet of Things (mIoT) service for Internet of Things (IoT) devices; an Ultra-Reliable Low Latency Communication (URLLC) service for mission critical devices such as medical monitoring devices, autonomous vehicles, industrial automation, etc.; and/or other types of wireless communication services. Each type of communication service may be associated with a different set of requirements.

An important feature of 5G networks is the use of multiple-input and multiple-output (MIMO) communication. MIMO communication includes sending and receiving multiple data signals simultaneously over a same radio frequency (RF) channel using multiple antennas and/or antenna elements. For example, a UE device and a base station in a RAN may each include an adaptive antenna array with multiple antenna elements. If different antenna elements of a transmitting antenna array are able to transmit data with different signal propagation properties (e.g., by having different polarizations, etc.), a receiving antenna array may be able to receive and decode multiple signals simultaneously, thereby increasing the throughput of the data being transmitted.

In an ideal scenario, transmitting antennas of an antenna array may be able to transmit simultaneous streams of data. However, in real world situations, interference between individual signal paths may decrease the reliability of particular signal paths and reduce the total rate of transmission by the antenna array. In a communication channel with m transmitting antennas and n receiving antennas, the signal transmission may be modeled as an m by n channel matrix that includes all m×n paths between the transmitting antennas and the receiving antennas.

The rank of a matrix is a measure of the number of linearly independent vectors (i.e., rows or columns) of the matrix. Thus, the rank of a channel matrix may indicate how many data streams may be spatially multiplexed on a MIMO communication channel. The rank of a MIMO channel matrix may be referred to as a “MIMO rank.” As an example, a single antenna may be associated with a MIMO rank of 1. As another example, a 2×2 antenna array may be associated with MIMO rank values between a value of 2, corresponding to an ideal situation, and a value of 1, corresponding to a worst-case scenario in which the throughput of the 2×2 antenna array is no better than a single antenna. As yet another example, a 4×4 antenna array may be associated with MIMO rank values between 4 and 2, etc. Massive MIMO antenna arrays may have hundreds, or even thousands of antenna elements. Data sent via MIMO transmission may be mapped onto two codewords transmitted simultaneously. Even in MIMO transmission schemes with a MIMO rank higher than 2, two codewords may be used, as increasing the number of codewords beyond 2 may not significantly enhance performance.

A UE device may estimate the MIMO rank for a MIMO communication channel between the UE device and a base station by measuring reference signals transmitted by the base station. The UE device may determine a MIMO rank based on the measured reference signals and report the determined MIMO rank to the base station. The base station may then schedule downlink data transmission to the UE device based on the reported MIMO rank. For example, the base station may send downlink channel information (DCI) to the UE device in a Physical Downlink Control Channel (PDCCH) that enables the UE device to decode data transmitted to the UE device by the base station via a Physical Downlink Shared Channel (PDSCH). The DCI information may include the MIMO configuration selected by the base station to transmit the data.

A UE device may report a lower MIMO rank than the MIMO rank determined by the UE device based on measured reference signal. For example, a manufacturer of a wireless chipset for the UE device may intentionally configure the wireless chipset to report a lower MIMO rank in order to conserve battery power, since using fewer antenna elements requires using less power. However, using a lower MIMO rank than is available may result in inefficient use of network resources, because the base station may need to schedule more resource blocks to transmit the same amount of data to the UE device. Furthermore, other UE devices serviced by the base station may experience a lower throughput as a result.

Implementations described herein relate to systems and methods for MIMO rank indicator override. A device associated with a base station may be configured to override a MIMO rank indicator received from a UE device and transmit data to the UE device at a higher MIMO rank than the MIMO rank identified by the received MIMO rank indicator. For example, the device may be configured to receive a MIMO rank indicator from the UE device, determine that the received MIMO rank indicator is lower than an expected MIMO rank indicator, determine that the UE device satisfies one or more criteria for a MIMO rank indicator override, and override the MIMO rank indicator for the UE device, in response to determining that the received MIMO rank indicator is lower than the expected MIMO rank indicator and determining that the UE device satisfies the one or more criteria for the MIMO rank indicator override.

Overriding the MIMO rank indicator for the UE device may include selecting a MIMO rank greater than the received MIMO rank indicator sent by the UE device and including information identifying the selected MIMO rank in DCI sent to the UE device. Receiving the MIMO rank indicator sent from the UE device may include retrieving the MIMO rank indicator from a measurement report sent from the UE device. Determining that the received MIMO rank indicator is lower than the expected MIMO rank indicator may include determining the expected MIMO rank indicator based on at least one of a Sounding Reference Signal (SRS) associated with the UE device or a Precoding Matrix Indicator (PMI) associated with the UE device.

Determining that the UE device satisfies one or more criteria for the MIMO rank indicator override may include determining that a channel quality value associated with the UE device is greater than a channel quality threshold, determining that a cell loading condition associated with the UE device is greater than a cell loading threshold, and/or determining that the UE device has been classified as a candidate for the MIMO rank indicator override. Determining that the UE device has been classified as the candidate for the MIMO rank indicator override may be based on at least one of an application in use by the UE device, a Quality of Service (QoS) parameter for a data flow associated with the UE device, a network slice in use by the UE device, a Multi-Access Edge Computing (MEC) service in use by the UE device, and/or a location associated with the UE device.

The device may be further configured to determine whether overriding the MIMO rank indicator was appropriate. Overriding the MIMO rank indicator may be appropriate if the higher MIMO rank does not result in an increased signal error rate as measured by the UE device. For example, the device may be configured to determine whether a block error rate (BLER) associated with the UE device is less than a BLER threshold. If the BLER is less than the BLER threshold, the base station may continue to override the MIMO rank indicator for the UE device, in response to determining that the BLER associated with the UE device is less than the BLER threshold. If the BLER is not less than the BLER threshold for at least a particular number of time slots or a particular time period, the base station may cease to override the MIMO rank indicator for the UE device and revert to a MIMO rank corresponding to the MIMO rank identified in the MIMO rank indicator received from the UE device. In some implementations, rather than reverting to a MIMO rank identified in the MIMO rank indicator, the base station may reduce the MIMO rank to a value between the overridden MIMO rank and the MIMO rank identified in the MIMO rank indicator.

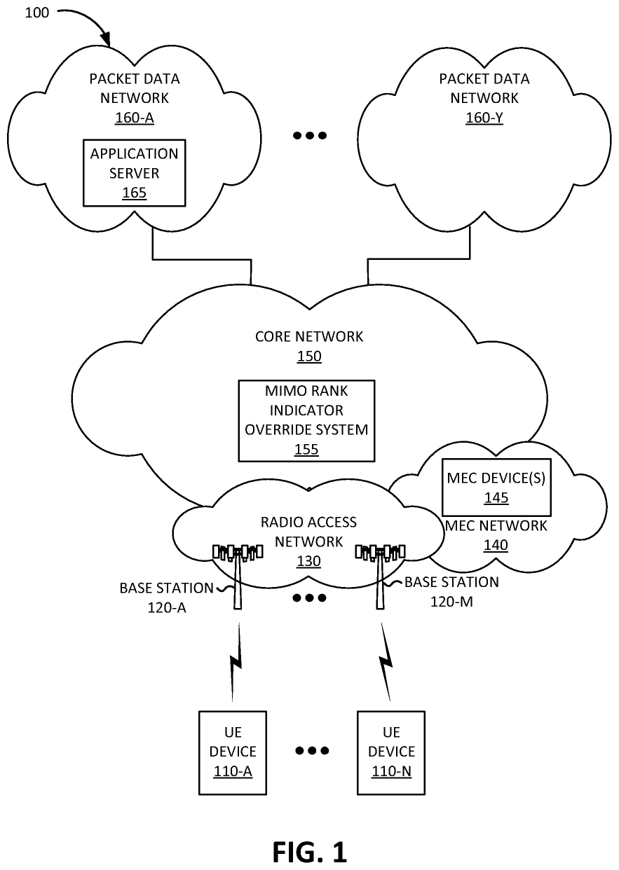

FIG. 1 is a diagram of an exemplary environment 100 in which the systems and/or methods described herein may be implemented. As shown in FIG. 1, environment 100 may include UE devices 110-A to 110-N (referred to herein collectively as “UE devices 110” and individually as “UE device 110”), a RAN 130 that includes base stations 120-A to 120-M (referred to herein collectively as “base stations 120” and individually as “base station 120”), a Multi-Access Edge Computing (MEC) network 140, a core network 150, and packet data networks (PDNs) 160-A to 160-Y (referred to herein collectively as “PDNs 160” and individually as “PDN 160”).

UE device 110 may include any mobile device with cellular wireless communication functionality. UE device 110 may include a handheld wireless communication device (e.g., a mobile phone, a smart phone, a tablet device, etc.); a wearable computer device (e.g., a head-mounted display computer device, a wristwatch computer device, etc.); a laptop computer, a tablet computer, a portable gaming system, and/or another type of portable computer; a WiFi access point (AP); a Fixed Wireless Access (FWA) device; and/or any other type of mobile computer device with cellular wireless communication capabilities. In some implementations, UE device 110 may communicate using machine-to-machine (M2M) communication, such as Machine Type Communication (MTC), and/or another type of M2M communication for IoT applications.

Base station 120 may include a 5G New Radio (NR) base station (e.g., a gNodeB) and/or a Fourth Generation (4G) Long Term Evolution (LTE) base station (e.g., an eNodeB). Each base station 120 may include devices and/or components configured to enable cellular wireless communication with UE devices 110. For example, base station 120 may include an RF transceiver configured to communicate with UE devices 110 using a 5G NR air interface using a 5G NR protocol stack, a 4G LTE air interface using a 4G LTE protocol stack, and/or using another type of cellular air interface.

RAN 130 may include base stations 120 and be managed by a provider of wireless communication services. RAN 130 may enable UE devices 110 to connect to core network 150 via base stations 120 using cellular wireless signals. For example, RAN 130 may include one or more central units (CUs), distributed units (DUs), and/or Radio Units (RUs) (not shown in FIG. 1) that enable and manage connections from RUs to core network 150. RAN 130 may include features associated with an LTE Advanced (LTE-A) network and/or a 5G network or other advanced network, such as management of 5G NR base stations; carrier aggregation; advanced or massive MIMO configurations (e.g., an 8×8 antenna configuration, a 16×16 antenna configuration, a 256×256 antenna configuration, etc.); cooperative MIMO (CO-MIMO); relay stations; Heterogeneous Networks (HetNets) of overlapping small cells and macrocells; Self-Organizing Network (SON) functionality; MTC functionality, such as 1.4 Megahertz (MHz) wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of LTE-A and/or 5G functionality.

MEC network 140 may be associated with one or more base stations 120 and may provide MEC services for UE devices 110 attached to the base stations 120. MEC network 140 may be in proximity to base stations 120 from a geographic and network topology perspective, thus enabling low latency services to be provided to UE devices 110. As an example, MEC network 140 may be located on the same site as base station 120. As another example, MEC network 140 may be geographically closer to one of base stations 120 and reachable via fewer network hops and/or fewer switches, than other base stations 120.

MEC network 140 may include one or more MEC devices 145. MEC devices 145 may provide MEC services to UE devices 110. A MEC service may include, for example, a low-latency microservice associated with a particular application, a microservice associated with a virtualized network function (VNF) of core network 150, a cloud computing service, such as cache storage service, artificial intelligence (AI) accelerator service, machine learning service, an image processing service, a data compression service, a locally centralized gaming service, a Graphics Processing Units (GPUs) and/or other types of hardware accelerator service, and/or other types of cloud computing services.

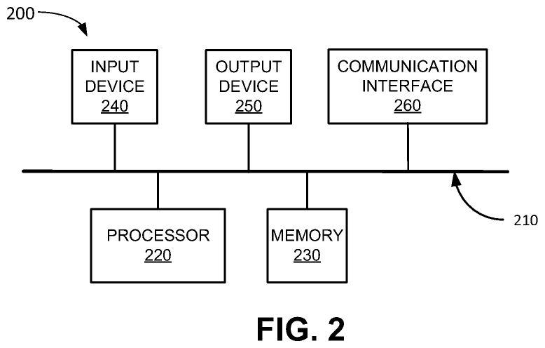

Core network 150 may be managed by the provider of cellular wireless communication services and may manage communication sessions of subscribers connecting to core network 150 via RAN 130. For example, core network 150 may establish an Internet Protocol (IP) connection between UE devices 110 and PDN 160. In some implementations, core network 150 may include a 5G core network. The components of core network 150 may be implemented as dedicated hardware components and/or as Virtual Network Functions (VNFs) implemented on top of a common shared physical infrastructure using Software Defined Networking (SDN). For example, an SDN controller may implement one or more of the components of core network 150 using an adapter implementing a VNF virtual machine, a Cloud-Native Network Function (CNF) container, an event driven serverless architecture, and/or another type of SDN architecture. The common shared physical infrastructure may be implemented using one or more devices 200 described below with reference to FIG. 2 in a cloud computing center associated with core network 150. Additionally, or alternatively, some, or all, of the common shared physical infrastructure may be implemented using one or more devices 200 included in MEC network 140.

Core network 150 may include a MIMO rank indicator override system 155. MIMO rank indicator override system 155 may be configured to override a MIMO rank indicator received from UE device 110 by base station 120 and cause base station 120 to transmit data to UE device 110 at a higher MIMO rank than the MIMO rank identified by the received MIMO rank indicator. While MIMO rank indicator override system 155 is shown in core network 150 for illustrative purposes, in other implementations, MIMO rank indicator override system 155 may be implemented as part of base station 120. In yet other implementations, MIMO rank indicator override system 155 may be implemented in a different device that is part of RAN 130, such as a DU or a CU. In yet other implementations, MIMO rank indicator override system 155 may be implemented in MEC device 145.

PDNs 160-A to 160-Y may each be associated with a Data Network Name (DNN) in 5G, and/or an Access Point Name (APN) in 4G. UE device 110 may request a connection to PDN 160 using a DNN or an APN. For example, UE device 110 request a connection to an application server 165 (shown in PDN 160-A for illustrative purposes). PDN 160 may include, and/or be connected to, a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks. PDN 160 may include application server 165. Application server 165 may include one or more computer devices that host one or more applications and/or other types of services used by UE device 110. Core network 150 may establish a data flow session between UE device 110 and application server 165 via RAN 130.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

FIG. 2 is a diagram illustrating example components of a device 200 according to an implementation described herein. Each of the components of FIG. 1 may include, or be implemented on, one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, central processing unit (CPU), graphics processing unit (GPU), tensor processing unit (TPU), hardware accelerator, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some implementations, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying content to the user. In some implementations, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to radio frequency (RF) signals and/or a receiver that converts RF signals to baseband signals. Communication interface 260 may be coupled to an antenna for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 200 may perform certain operations relating to MIMO rank indicator override. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally, or alternatively, one or more components of device 200 may perform one or more tasks described as being performed by one or more other components of device 200.

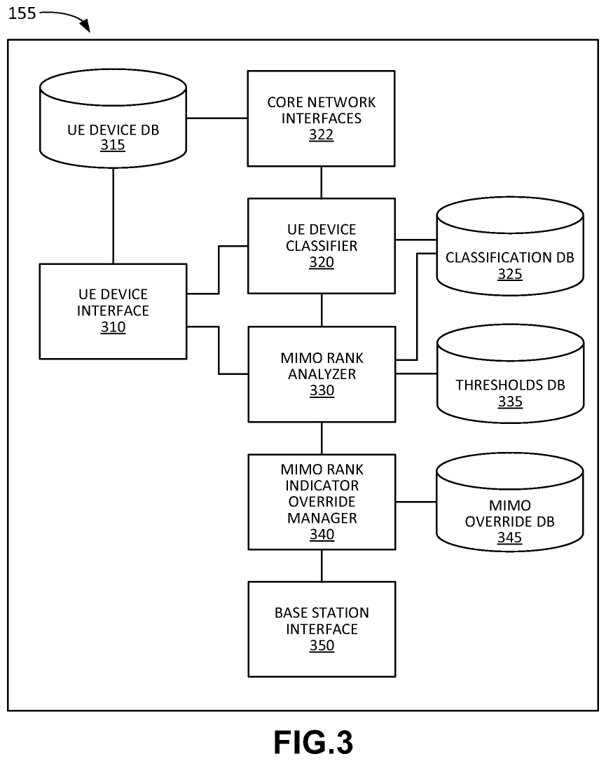

FIG. 3 is a diagram illustrating exemplary components of MIMO rank indicator override system 155. The components of MIMO rank indicator override system 155 may be implemented, for example, via processor 220 executing instructions from memory 230. For example, one or more components of MIMO rank indicator override system 155 may correspond to the structure of processor 220 together with instructions in memory 230 for implementing the functionality of the component. Alternatively, or additionally, some or all the components of MIMO rank indicator override system 155 may be implemented via hard-wired circuitry. For example, one or more components of MIMO rank indicator override system 155 may correspond to the structure of some or all of an ASIC, FPGA, and/or another type of integrated circuit. Furthermore, some or all of the components of MIMO rank indicator override system 155 may be implemented in base station 120. As shown in FIG. 3, MIMO rank indicator override system 155 may include a UE device interface 310, a UE device database (DB) 315, a UE device classifier 320, core network interfaces 322, a classification DB 325, a MIMO rank analyzer 330, a thresholds DB 335, a MIMO rank indicator override manager 340, a MIMO override DB 345, and a base station interface 350.

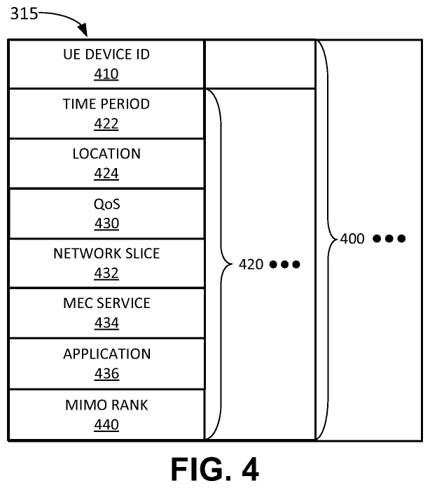

UE device interface 310 may be configured to communicate with UE device 110. For example, UE device interface 310 may receive a measurement report, which includes a MIMO rank indicator, from UE device 110. As another example, UE device interface 310 may receive information relating to data flow sessions, associated with UE device 110, from UE device. UE device interface 310 may store information received from UE device 110 in UE device DB 315. Exemplary information that may be stored in UE device DB 315 is described below with reference to FIG. 4. Core network interfaces 312 may be configured to communicate with devices in core network 150. For example, core network interfaces 322 may receive information relating to data flow sessions for UE device 110 from devices in core network 150 managing the data flows (e.g., from a Session Management Function, User Plane Function, Policy Control Function, etc.), and store the received information in UE device DB 315.

UE device classifier 320 may classify UE device 110 as a candidate for MIMO rank indicator override or as a non-candidate for MIMO rank indicator override. As an example, MIMO rank indicator override may be important for particular situations, such as when UE device 110 requires high throughput and/or low latency, and/or when UE device 110 is at particular locations where high throughput and/or low latency are more important. UE device classifier 320 may determine a location for UE device 110, an application ID for an application session associated with UE device 110, a QoS parameter for a data flow associated with UE device 110, a network slice to which UE device 110 has been admitted, a MEC service being used by UE device 110, and/or other types of information that may be used to classify UE device 110. UE device classifier 320 may compare the obtained information associated with UE device 110 to information stored in classification DB 325 to determine whether UE device 110 should be classified as a candidate for MIMO rank indicator override.

As an example, candidate criteria, stored in classification DB 325, for a MIMO rank indicator override may include a list of specific application types, QoS parameters, network slices, locations, and/or MEC services. If the collected information for UE device 110 includes at least one item on the list, UE device 110 may be classified as a candidate for MIMO rank indicator override. In other implementations, each item on the list may be assigned a weight and all the weights may be combined (e.g., as a straight sum, as a weighted average, etc.) and compared to a classifying threshold. If the items from the collected information for UE device 110 combine to a value higher than the classifying threshold, UE device 110 may be classified as a candidate for a MIMO rank indicator override. If UE device 110 does not satisfy the requirements for a MIMO rank indicator override, UE device 110 may not be classified as a candidate for a MIMO rank indicator override. In order to conserve resources of RAN 130 and/or core network 150 and improve efficiency of MIMO communication, only candidate UE devices 110 may be considered when determining whether to apply a MIMO rank indicator override.

MIMO rank analyzer 330 may determine, when analyzing a received MIMO rank indicator, whether UE device 110 associated with the received MIMO rank indicator is a candidate for MIMO rank indicator override by checking classification DB 325. If UE device 110 corresponds to a candidate for MIMO rank indicator override, MIMO rank analyzer 330 may analyze the MIMO rank indicator to determine whether the MIMO rank reported by the MIMO rank indicator is lower than an expected MIMO rank. MIMO rank analyzer 330 may determine an expected MIMO rank for UE device 110 based on at least one of an SRS or a PMI associated with UE device 110. For example, MIMO rank analyzer 330 may use SRS transmissions received from UE device 110 to determine the uplink signal quality associated with different signal paths between UE device 110 and base station 120. MIMO rank analyzer 330 may then determine the most appropriate MIMO settings for sending signals to UE device 110 based on the determined uplink signal quality (e.g., since different reference signals are sent using different antenna elements, etc.).

The PMI may be selected and sent to base station 120 by UE device 110 based on the precoding preferred by UE device 110 and may be based on the MIMO configuration preferred by UE device 110. Thus, base station 120 may compare the PMI to the MIMO configuration associated with the PMI to determine an expected MIMO rank associated with UE device 110. MIMO rank analyzer 330 may determine that the expected MIMO rank is higher than the MIMO rank reported in the MIMO rank indicator and, in response, determine that a MIMO rank indicator override determination process should be carried out. If the expected MIMO rank is not higher than the reported MIMO rank, overriding the MIMO rank indicator for UE device 110 may not be performed.

MIMO rank analyzer 330 may further check whether requirements for performing a MIMO rank indicator override are satisfied by determining a signal quality value for UE device 110 and/or by determining a cell loading condition associated with UE device 110. For example, MIMO rank analyzer 330 may determine a channel quality value for UE device 110, such as, for example, a Channel Quality Indicator (CQI) value, a Reference Signal Received Power (RSRP) value, a Reference Signal Received Quality (RSRQ) value, a Received Signal Strength Indicator (RSSI) value, a Signal to Interference and Noise Ratio (SINR) value, and/or another type of signal quality value. MIMO rank analyzer 330 may compare the determined channel quality value to a channel quality threshold, such as, for example, a CQI threshold, an RSRP threshold, an RSRQ threshold, an RSSI threshold, a SINR threshold, and/or another type of channel quality threshold stored in thresholds DB 335.

Furthermore, MIMO rank indicator override system 155 may determine a cell loading condition value associated with UE device 110, such as, for example, a Physical Resource Block (PRB) utilization rate value, a Transmission Time Interval (TTI) utilization rate value, cell downlink throughput value, cell uplink throughput value, and/or another type of cell loading condition value. MIMO rank analyzer 330 may compare the determined cell loading condition value to a cell loading condition threshold, such as, for example, a PRB utilization rate threshold, a TTI utilization rate threshold, cell downlink throughput threshold, cell uplink throughput threshold, and/or another type of cell loading condition threshold stored in thresholds DB 335.

If UE device 110 corresponds to a candidate for MIMO rank indicator override, if the MIMO rank reported in the MIMO rank indicator is lower than an expected MIMO rank, and if UE device 110 satisfies the channel quality and/or cell loading requirement for a MIMO rank indicator override, MIMO rank analyzer 330 may instruct MIMO rank indicator override manager 340 to override the MIMO rank indicator for UE device 110.

MIMO rank indicator override manager 340 may instruct base station 120 to override the MIMO rank indicator for UE device 110 using base station interface 350. Thus, base station interface 350 may interface with base station 120 to receive information from base station 120 to MIMO rank indicator override system 155, and/or to send instructions to base station 120. In response to receiving the instruction, base station 120 may select a MIMO rank that is greater than the received MIMO rank indicator for UE device 110 and may include information identifying the selected MIMO rank in DCI sent to UE device 110 at the next scheduling opportunity. MIMO rank indicator override manager 340 may store an indication in MIMO override DB 345 that UE device 110 is associated with a MIMO rank indicator override. Thus, MIMO override DB 345 may store information identifying all UE devices 110, serviced by base station 120, which are associated with a MIMO rank indicator override.

Furthermore, MIMO rank indicator override manager 340 may monitor errors associated with the codewords received by UE device 110 from base station 120 to determine whether the error rate has increased as a result of the higher MIMO rank. For example, MIMO rank indicator override manager 340 may determine whether the BLER associated with at least one codeword is below a BLER threshold. If at least one codeword has a BLER that is below a BLER threshold, MIMO rank indicator override manager 340 may continue to override the MIMO rank indicator for UE device 110. If no codewords have a BLER that is below a BLER threshold, MIMO rank indicator override manager 340 may determine whether at least one codeword is above a BLER threshold for a set duration (e.g., for at least an x number of time slots or y milliseconds). If at least one codeword is above the BLER threshold for the set duration, MIMO rank indicator override manager 340 may cease overriding the MIMO rank indicator for UE device 110. Otherwise, MIMO rank indicator override manager 340 may continue to override the MIMO rank indicator for UE device 110.

Although FIG. 3 shows exemplary components of MIMO rank indicator override system 155, in other implementations, MIMO rank indicator override system 155 may include fewer components, different components, additional components, or differently arranged components than depicted in FIG. 3. Additionally, or alternatively, one or more components of MIMO rank indicator override system 155 may perform one or more tasks described as being performed by one or more other components of MIMO rank indicator override system 155.

FIG. 4 illustrates exemplary components of user device DB 315. As shown in FIG. 4, user device DB 315 may include one or more UE device records 400. Each UE device record 400 may store information relating to a particular UE device 110 serviced by base station 120. UE device record 400 may include a UE device identifier (ID) field 410 and one or more time period records 420.

UE device ID field 410 may store information identifying a particular UE device 110. For example, UE device ID field 410 may store a Mobile Directory Number (MDN), an International Mobile Subscriber Identity (IMSI), a Mobile Station International Subscriber Directory Number (MSISDN), an International Mobile Equipment Identity (IMEI), an ID associated with the subscription for UE device 110 (e.g., a subscription ID, an account number, etc.), and/or another type of ID for the particular UE device 110.

Each time period record 420 may store information associated with a particular time period. Time period record 420 may include a time period field 422, a location field 424, a QoS field 430, a network slice field 432, a MEC service field 434, an application field 436, and a MIMO rank field 440. Time period field 422 may identify a time period during which information relating to UE device 110 was received. Location field 424 may store information identifying a location of UE device 110 during the time period.

QoS field 430 may store one or more QoS parameters associated with UE device 110 during the time period. For example, QoS parameters field 430 may store a 5G QoS ID (5QI) value for a data flow associated with UE device 110 during the time period. Furthermore, QoS parameters field 430 may store values for one or more additional QoS parameters for the data flow such as, for example, an Allocation and Retention Priority (ARP) value that defines a relative importance of data flow in light of resource limitations; a Reflective QoS Attribute (RQA) value that indicates whether QoS of downlink traffic to UE device 110 is reflected on uplink traffic; a Guaranteed Flow Bit Rate (GFBR) value; a Notification Control value that indicates whether notifications are requested from the RAN when the GFBR cannot be guaranteed; one or more Aggregate Maximum Bit Rate (AMBR) values, such as a per session AMBR, a per UE AMBR, etc.; a Maximum Packet Loss Rate (MPLR) value; and/or other types of QoS parameter values.

Network slice field 432 may store information identifying a network slice used by UE device 110 during the time period. MEC service field 434 may store information identifying whether UE device 110 used a MEC service during the time period and information identifying the MEC service, if UE device 110 used a MEC service during the time period. Application field 436 may store information identifying whether UE device 110 used an application during the time period and information identifying the application, if UE device 110 used the application during the time period. MIMO rank field 440 may store a MIMO rank identified by a MIMO rank indicator received from UE device 110 during the time period.

Although FIG. 4 shows exemplary components of user device DB 315, in other implementations, user device DB 315 may include fewer components, different components, additional components, or differently arranged components than depicted in FIG. 4.

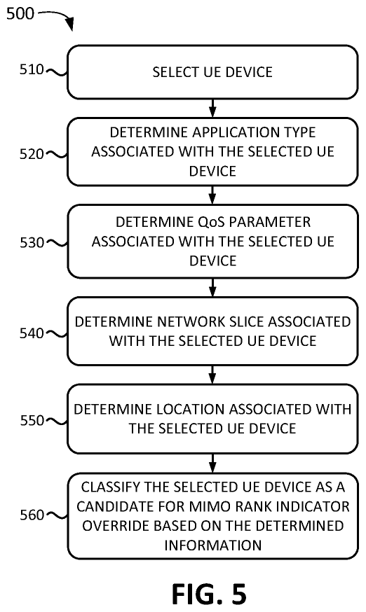

FIG. 5 illustrates a flowchart of a process 500 for classifying a UE device as a candidate for MIMO rank indicator override. In some implementations, process 500 of FIG. 5 may be performed by MIMO rank indicator override system 155. In other implementations, some or all of process 500 may be performed by another device or a group of devices separate from MIMO rank indicator override system 155.

As shown in FIG. 5, process 500 may include selecting a UE device (block 510). For example, MIMO rank indicator override system 155 may select UE device 110 serviced by base station 120 (e.g., from a list of UE devices 110 attached to, and/or registered with, base station 120). Process 500 may further include determining an application type associated with the selected UE device (block 520), determining a QoS parameter associated with the selected UE device (block 530), determining a network slice associated with the selected UE device (block 540), and determining a location associated with the selected UE device (block 550).

For example, MIMO rank indicator override system 155 may obtain information relating to data streams in a Protocol Data Unit (PDU) session associated with UE device 110. As an example, MIMO rank indicator override system 155 may access a scheduler at base station 110 to determine QoS parameters associated with data flows for UE device 110. Furthermore, MIMO rank indicator override system 155 may perform deep packet inspection at base station 120 on packets associated with UE device 110 to determine application IDs associated with data flows for UE device 110. MIMO rank indicator override system 155 may determine a network slice associated with UE device 110 based on a request for a network slice selection ID (e.g., Network Slice Selection Assistance Information (NSSAI) or a Single-NSSAI, etc.) received from UE device 110 and/or a network slice assignment sent to UE device 110 from core network 150. Furthermore, MIMO rank indicator override system 155 may determine a location associated with UE device 110 based on a area tracking update sent to base station 120 from UE device 110.

Additionally, or alternatively, MIMO rank indicator override system 155 may obtain information relating to QoS parameters, application IDs, and/or network slices associated with data flows for UE device 110 from core network 150 (e.g., from a Session Management Function, User Plane Function, Policy Control Function, etc.).

MIMO rank indicator override system 155 may determine application types for application IDs associated with UE device 110 based on a list of application IDs maintained by MIMO rank indicator override system 155. An application type may correspond, for example, to a real-time video application, a streaming application, a mission critical application, a real-time gaming application, etc.

MIMO rank indicator override system 155 may further obtain additional information relating to UE device 110. For example, MIMO rank indicator override system 155 may determine whether UE device 110 is using a MEC service associated with MEC network 140 and use the MEC service information to classify UE device 110. MIMO rank indicator override system 155 may determine whether UE device 110 is associated with a MEC service based on forwarding information obtained from RAN 130 and/or core network 150.

Process 500 may further include classifying the selected UE device as a candidate for MIMO rank indicator override based on the determined information (block 560). For example, MIMO rank indicator override system 155 may determine whether UE device 110 is associated with a high throughout requirement, a low latency requirement and/or another type of requirement that may benefit from a MIMO rank indicator override. MIMO rank indicator override system 155 may use the collected information relating to the location, application type, QoS parameters, network slices, and/or MEC services to classify UE device 110 into a candidate or non-candidate for a MIMO rank indicator override based on a set of one or more criteria stored in classification DB 325.

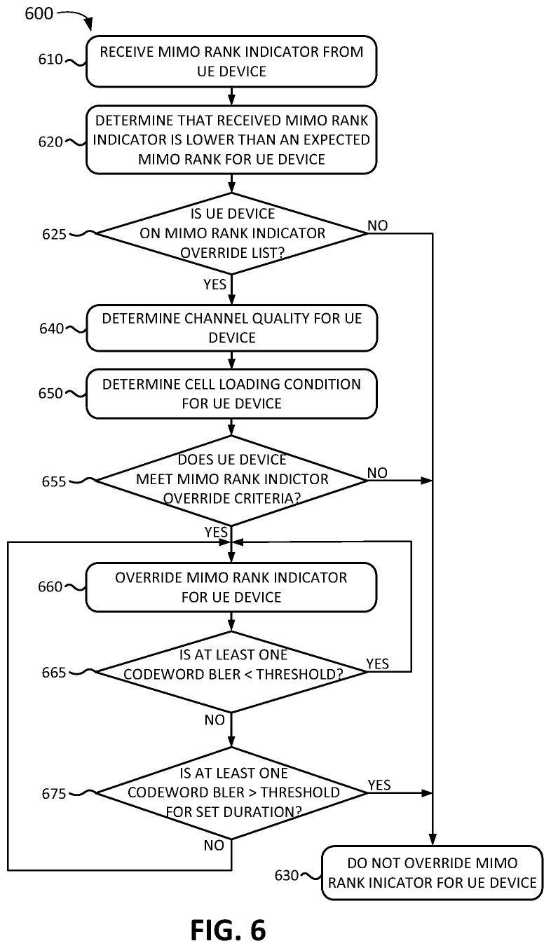

FIG. 6 illustrates a flowchart of a process 600 for performing a MIMO rank indicator override. In some implementations, process 600 of FIG. 6 may be performed by MIMO rank indicator override system 155. In other implementations, some or all of process 600 may be performed by another device or a group of devices separate from MIMO rank indicator override system 155.

As shown in FIG. 6, process 600 may include receiving a MIMO rank indicator from a UE device (block 610). For example, base station 120 may receive a MIMO rank indicator in a measurement report sent by UE device 110 and provide the received MIMO rank indicator to MIMO rank indicator override system 155. Process 600 may further include determining that the received MIMO rank indicator is lower than an expected MIMO rank for the UE device (block 620). For example, MIMO rank indicator override system 155 may determine an expected MIMO rank for UE device 110 based on at least one of an SRS or a PMI associated with UE device 110. MIMO rank indicator override system 155 may determine that the expected MIMO rank is higher than the MIMO rank reported in the MIMO rank indicator and continue to block 625 to determine that a MIMO rank indicator override determination process should be carried out. In situations in which the expected MIMO rank is not higher than the reported MIMO rank, overriding the MIMO rank indicator for UE device 110 may not be performed and the rest of process 600 may not need to be performed.

A determination may be made as to whether the UE device is on a MIMO rank indicator override list (block 625). For example, MIMO rank indicator override system 155 may determine whether UE device 110 is on a candidate list for MIMO rank indicator override maintained in classification DB 325. If it is determined that the UE device is not on the MIMO rank indicator override list (block 625—NO), overriding the MIMO rank indicator for the UE device may not be performed (block 630).

If it is determined that the UE device is on the MIMO rank indicator override list (block 625—YES), the channel quality for the UE device may be determined (block 640), and the cell loading condition for the UE device may be determined (block 650). For example, MIMO rank indicator override system 155 may determine a channel quality value for UE device 110, such as, for example, a CQI value, an RSRP value, an RSRQ value, an RSSI value, a SINR value, etc., and compare the determined channel quality value to a channel quality threshold, such as, for example, a CQI threshold, an RSRP threshold, an RSRQ threshold, an RSSI threshold, a SINR threshold, etc. Furthermore, MIMO rank indicator override system 155 may determine a cell loading condition value associated with UE device 110, such as, for example, a PRB utilization rate value, a TTI utilization rate value, cell downlink throughput value, cell uplink throughput value, etc., and compare the determined cell loading condition value to a cell loading condition threshold, such as, for example, a PRB utilization rate threshold, a TTI utilization rate threshold, cell downlink throughput threshold, cell uplink throughput threshold, etc.

A determination may be made as to whether the UE device meets MIMO rank indicator override criteria (block 655). For example, MIMO rank indicator override system 155 may determine whether one or more channel quality threshold requirements and/or one or more cell loading condition threshold are satisfied for UE device 110. If it is determined that the UE device does not meet the MIMO rank indicator override criteria (block 655—NO), overriding the MIMO rank indicator for the UE device may not be performed (block 630).

If it is determined that the UE device does meet the MIMO rank indicator override criteria (block 655—YES), overriding the MIMO rank indicator for the UE device may be performed (block 660). For example, MIMO rank indicator override system 155 may instruct base station 120 to override the MIMO rank indicator for UE device 110. In response, base station 120 may select a MIMO rank that is greater than the received MIMO rank indicator for UE device 110 and may include information identifying the selected MIMO rank in DCI sent to UE device 110 at the next scheduling opportunity.

A determination may be made as to whether the BLER for at least one codeword is below a BLER threshold (block 665). For example, after sending the DCI to UE device 110 with the selected MIMO rank, MIMO rank indicator override system 155 may determine whether the selecting a MIMO rank higher than the reported MIMO rank in the MIMO rank indicator was appropriate by determining whether the reliability of the communication path from base station 120 to UE device 110 has decreased. MIMO rank indicator override system 155 may determine whether the reliability has decreased by measuring the BLER of the codewords received by UE device 110.

If it is determined that the BLER for at least one codeword is below a BLER threshold (block 665—YES), processing may return to block 660 to continue to override the MIMO rank indicator for the UE device. If it is determined that the BLER for at least one codeword is not below a BLER threshold (block 665—NO), a determination may be made to as to whether at least one codeword is above a BLER threshold for a set duration (block 675). For example, MIMO rank indicator override system 155 may determine whether at least one codeword, of the two codewords associated with the MIMO communication path, is associated with a BLER that is above a BLER threshold for at least an x number of time slots or y milliseconds.

If it is determined that at least one codeword is above the BLER threshold for a set duration (block 675—YES), processing may proceed to block 630 to cease overriding the MIMO rank indicator for the UE device. If it is determined that at least one codeword is not above the BLER threshold for a set duration (block 675—NO), processing may return to block 660 to continue to override the MIMO rank indicator for the UE device.

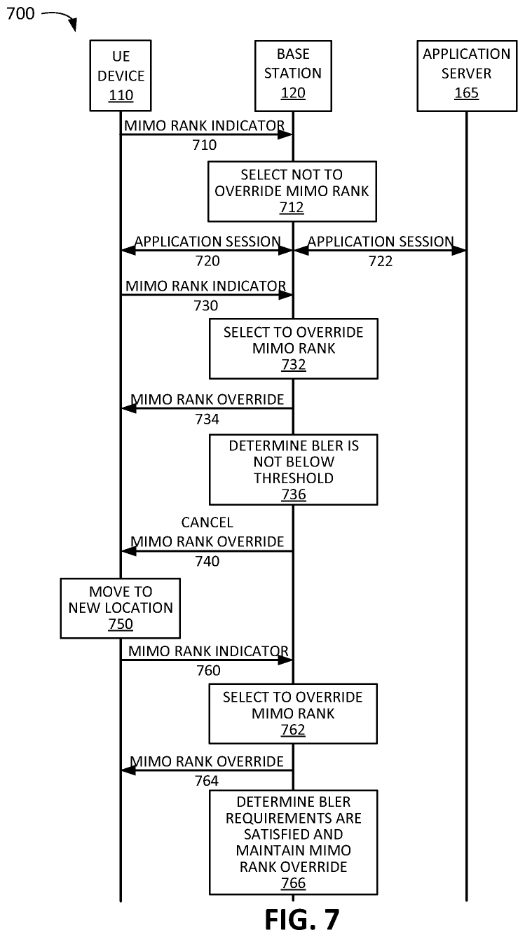

FIG. 7 illustrates an exemplary signal flow 700 diagram according to an implementation described herein. As shown in FIG. 7, signal flow 700 includes UE device 110 sending a MIMO rank indicator to base station 120 (signal 710). Base station 120, which may include MIMO rank indicator override system 155, may determine that UE device 110 has not been classified as a candidate or MIMO rank indicator override, because UE device 110 is not associated with high throughput requirement or low latency requirement applications. Thus, base station 120 may select not to override the MIMO rank indicator (block 712).

At a later time, UE device 110 may initiate an application session with application server 165 via base station 120 (signals 720 and 722). The application session may correspond to a video streaming application with a low latency requirement and a high throughput requirement. As a result, base station 120 may classify UE device 110 as a candidate for MIMO rank indicator override. UE device 110 may send another MIMO rank indicator to base station 120 (signal 730) and base station 120 may detect that UE device 110 is a candidate or MIMO rank indicator override. Base station 120 may check the channel quality for UE device 110, and/or the loading condition for the cell of base station 120 associated with UE device 110, and determine that UE device 110 satisfies a channel quality threshold and a cell loading threshold to activate a MIMO rank indicator override. In response, base station 120 may select to override the reported MIMO rank in the received MIMO rank indicator (block 732) and may override the MIMO rank by including a higher MIMO rank in the DCI information sent to UE device 110 at the next scheduling opportunity (signal 734).

Subsequently, base station 120 may measure the channel quality for UE device 110 and may determine that a BLER for a codeword received by UE device 110 is not below a BLER threshold (block 736). Thus, the higher MIMO rank has resulted in a degraded signal quality. In response, base station 120 may cancel the MIMO rank indicator override by reverting to the lower MIMO rank received in the most recent MIMO rank indicator by including the lower MIMO rank in the DCI information sent to UE device 110 at the next scheduling opportunity (signal 740).

At a later time, UE device 110 may move to a new location (block 750). Alternatively, UE device 110 may stay in the same location and the multipath fading conditions in the location may change (e.g., as a result of traffic, weather, etc.). UE device 110 may send another MIMO rank indicator to base station 120 (signal 760) and base station 120 may detect that UE device 110 is a candidate or MIMO rank indicator override. Base station 120 may check the channel quality for UE device 110, and/or the loading condition for the cell of base station 120 associated with UE device 110, and determine that UE device 110 satisfies a channel quality threshold and a cell loading threshold to activate a MIMO rank indicator override. In response, base station 120 may select to override the reported MIMO rank in the received MIMO rank indicator (block 762) and may override the MIMO rank by including a higher MIMO rank in the DCI information sent to UE device 110 at the next scheduling opportunity (signal 764).

Subsequently, base station 120 may measure the channel quality for UE device 110 and may determine that a BLER for a codeword received by UE device 110 is below a BLER threshold and that the BLER requirements are satisfied (block 766). In response, base station 120 may maintain the MIMO rank indicator override.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 5 and 6, and a series of signals have been described with respect to FIG. 7, the order of the blocks, and/or signals, may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
receiving, by a device, a multiple-input and multiple-output (MIMO) rank indicator from a user equipment (UE) device;
determining, by the device, that the received MIMO rank indicator is lower than an expected MIMO rank indicator;
determining, by the device, that the UE device satisfies one or more criteria for a MIMO rank indicator override; and
overriding, by the device, the MIMO rank indicator for the UE device, in response to determining that the received MIMO rank indicator is lower than the expected MIMO rank indicator and determining that the UE device satisfies the one or more criteria for the MIMO rank indicator override.

2. The method of claim 1, wherein receiving the MIMO rank indicator from the UE device includes:
retrieving the MIMO rank indicator from a measurement report received from the UE device.

3. The method of claim 1, wherein determining that the received MIMO rank indicator is lower than the expected MIMO rank indicator includes:
determining the expected MIMO rank indicator based on at least one of a Sounding Reference Signal (SRS) associated with the UE device or a Precoding Matrix Indicator (PMI) associated with the UE device.

4. The method of claim 1, wherein determining that the UE device satisfies one or more criteria for the MIMO rank indicator override includes:
determining that a channel quality value associated with the UE device is greater than a channel quality threshold.

5. The method of claim 1, wherein determining that the UE device satisfies one or more criteria for the MIMO rank indicator override includes:
determining that a cell loading condition associated with the UE device is greater than a cell loading threshold.

6. The method of claim 1, wherein determining that the UE device satisfies one or more criteria for the MIMO rank indicator override includes:
determining that the UE device has been classified as a candidate for the MIMO rank indicator override.

7. The method of claim 6, wherein the UE device is classified as a candidate for the MIMO rank indicator override based on at least one of:
an application in use by the UE device,
a Quality of Service (QoS) parameter for a data flow associated with the UE device,
a network slice in use by the UE device,
a Multi-Access Edge Computing (MEC) service in use by the UE device, or
a location associated with the UE device.

8. The method of claim 1, wherein overriding the MIMO rank indicator for the UE device includes:
selecting a MIMO rank greater than the received MIMO rank indicator for the UE device; and
including information identifying the selected MIMO rank in downlink channel information (DCI) sent to the UE device.

9. The method of claim 1, further comprising:
determining that a block error rate (BLER) associated with the UE device is less than a BLER threshold; and
continuing to override the MIMO rank indicator for the UE device, in response to determining that the BLER associated with the UE device is less than the BLER threshold.

10. The method of claim 1, further comprising:
determining that a block error rate (BLER) associated with the UE device is greater than a BLER threshold for a particular number of slots or a particular time period; and
ceasing to override the MIMO rank indicator for the UE device, in response to determining that the BLER associated with the UE device is greater than the BLER threshold for the particular number of slots or the particular time period.

11. A device comprising:
a processor configured to:
receive a multiple-input and multiple-output (MIMO) rank indicator from a user equipment (UE) device;
determine that the received MIMO rank indicator is lower than an expected MIMO rank indicator;
determine that the UE device satisfies one or more criteria for a MIMO rank indicator override; and
override the MIMO rank indicator for the UE device, in response to determining that the received MIMO rank indicator is lower than the expected MIMO rank indicator and determining that the UE device satisfies the one or more criteria for the MIMO rank indicator override.

12. The device of claim 11, wherein, when determining that the received MIMO rank indicator is lower than the expected MIMO rank indicator, the processor is further configured to:
determine the expected MIMO rank indicator based on at least one of a Sounding Reference Signal (SRS) associated with the UE device or a Precoding Matrix Indicator (PMI) associated with the UE device.

13. The device of claim 11, wherein, when determining that the UE device satisfies one or more criteria for the MIMO rank indicator override, the processor is further configured to:
determine that a channel quality value associated with the UE device is greater than a channel quality threshold.

14. The device of claim 11, wherein, when determining that the UE device satisfies one or more criteria for the MIMO rank indicator override, the processor is further configured to:
determine that a cell loading condition associated with the UE device is greater than a cell loading threshold.

15. The device of claim 11, wherein, when determining that the UE device satisfies one or more criteria for the MIMO rank indicator override, the processor is further configured to:
determine that the UE device has been classified as a candidate for the MIMO rank indicator override.

16. The device of claim 15, wherein the UE device is classified as a candidate for the MIMO rank indicator override based on at least one of:
an application in use by the UE device,
a Quality of Service (QoS) parameter for a data flow associated with the UE device,
a network slice in use by the UE device,
a Multi-Access Edge Computing (MEC) service in use by the UE device, or
a location associated with the UE device.

17. The device of claim 11, wherein, when overriding the MIMO rank indicator for the UE device, the processor is further configured to:
select a MIMO rank greater than the received MIMO rank indicator for the UE device; and
include information identifying the selected MIMO rank in downlink channel information (DCI) sent to the UE device.

18. The device of claim 11, wherein the processor is further configured to:
determine that a block error rate (BLER) associated with the UE device is less than a BLER threshold; and
continue to override the MIMO rank indicator for the UE device, in response to determining that the BLER associated with the UE device is less than the BLER threshold.

19. The device of claim 11, wherein the processor is further configured to:
determine that a block error rate (BLER) associated with the UE device is greater than a BLER threshold for a particular number of slots or a particular time period; and
cease to override the MIMO rank indicator for the UE device, in response to determining that the BLER associated with the UE device is greater than the BLER threshold for the particular number of slots or the particular time period.

20. A non-transitory computer-readable memory device storing instructions executable by a processor, the non-transitory computer-readable memory device comprising:
one or more instructions to receive a multiple-input and multiple-output (MIMO) rank indicator from a user equipment (UE) device;
one or more instructions to determine that the received MIMO rank indicator is lower than an expected MIMO rank indicator;
one or more instructions to determine that the UE device satisfies one or more criteria for a MIMO rank indicator override; and
one or more instructions to override the MIMO rank indicator for the UE device, in response to determining that the received MIMO rank indicator is lower than the expected MIMO rank indicator and determining that the UE device satisfies the one or more criteria for the MIMO rank indicator override.
